(19) United States
(12) Patent Application Publication
(10) Pub. No.: US 2010/0235129 A1
(43) Pub. Date: Sep. 16, 2010

(54) CALIBRATION OF MULTI-SENSOR SYSTEM

(75) Inventors: Manuj Sharma, Bangalore (IN); Shrikant Rao, Karnataka (IN); Lalitha Eswara, Bangalore (IN)

Correspondence Address: HONEYWELL/FOGG;Patent Services, 101 Columbia Road, P.O Box 2245, Morristown, NJ, 07962-2245, US

(73) Assignee: HONEYWELL INTERNATIONAL INC., Morristown, NJ (US)

(21) Appl. No.: 12/400,980

(22) Filed: Mar. 10, 2009

(51) Int. Cl. G06F 19/00; G01C 25/00

(52) U.S. Cl. 702/97; 702/104

(57) ABSTRACT

A method for preprocessing sensor data applicable to sensor fusion for one or more sensors mounted on a vehicle is presented. The method comprises obtaining sensor data relating to common obstacles between the vision sensors and a lidar sensor, calculating range and azimuth values for the common obstacles from the lidar sensor data, and calculating range and azimuth values for the common obstacles from the vision sensor data. Then the method correlates the lidar sensor data pertaining to the common obstacles with the vision sensors pixels, formulates translations between the range values of the common obstacles and the one or more sensor tilt parameters, and performs recursive least squares to estimate an estimated sensor tilt for the vision sensors that can reduce range errors in the vision sensors.

### BACKGROUND

Autonomous vehicles need accurate and reliable obstacle detection solutions to aid in navigation and obstacle avoidance. Typically, sensors such as vision sensors, radio detection and ranging (radar) sensors, or light detection and ranging (lidar) sensors are utilized to detect obstacles in an autonomous vehicle's path. Sensor fusion can be performed to combine the sensory data (or data derived from sensory data) from multiple sensors such that the resulting information is more accurate, complete, or dependable than would be possible when the sensors are used individually.

However, sensor fusion can give inaccurate outputs if the sensors are not accurately registered (calibrated). As a common practice, registration is done prior to the installation and usage of autonomous vehicles. But, with time and usage, these parameters need to be recalibrated. Misalignment errors can arise with the vision sensor or with a high resolution sensor which result in inaccurate ranging of obstacles in the sensor's field-of-view (FOV) during operation of the vehicle.

Traditional camera calibration parameters consist of intrinsic and extrinsic parameters. Intrinsic parameters are those that are particular to a specific camera and lens, such as focal length, principal point, lens distortion, and the like. Extrinsic parameters relate the camera to other world coordinate systems, and include camera yaw, pitch, roll, and three translation parameters. The intrinsic parameters give the mapping between the image plane and the camera coordinate system, whereas the extrinsic parameters give the mapping between the world and the image coordinate system. The most widely used and accepted method of extrinsic calibration uses a checkerboard pattern, wherein the corners of the checkerboard patterns are considered for mapping.

The checkerboard pattern computes the rotation and translation matrices for obtaining the camera's orientation and mounting parameters. One such method of calibration with a checkerboard is to have the camera observe a planar checkerboard pattern and solve for constraints between the views of the planar checkerboard calibration pattern from a camera and a laser range finder. This method is an offline procedure that emphasizes the estimation of the relative position of the camera with respect to the laser range finder. Using a checkerboard pattern is cumbersome when the vehicle is moving. Recalibration or correction of the existing calibration parameters is most beneficial when done on-line or dynamically as the vehicle is in operation.

### SUMMARY

Embodiments provide a method for calibrating sensors mounted on a vehicle. The method comprises obtaining sensor data relating to one or more common obstacles between the one or more vision sensors and a lidar sensor. Then the lidar sensor data pertaining to the one or more common obstacles with the one or more vision sensors pixels is correlated. The range and azimuth values for the one or more common obstacles from the lidar sensor data are calculated. Translations between the range values of the one or more common obstacles and the one or more sensor tilt parameters are formulated. A recursive least squares to estimate an estimated sensor tilt for the one or more vision sensors that can reduce range errors in the vision sensors is performed.

Another embodiment provides an autonomous vehicle navigation system comprising one or more vision sensors mounted on a vehicle, a lidar sensor mounted on the vehicle, and a processing unit coupled to the one or more vision sensors and the lidar sensor. The processing unit is operable to receive data pertaining to the initial alignment and mounting of the lidar sensor and the one or more vision sensors on the vehicle. The processing unit also receives data relating to one or more common obstacles between the one or more vision sensors and the lidar sensor. The range and azimuth values for the one or more common obstacles from the lidar sensor data are calculated. Data from the lidar sensor data pertaining to the one or more common obstacles is coordinated with data from the one or more vision sensors pixels. The processing unit formulates translations between the range values of the one or more common obstacles and the one or more sensor tilt parameters. The processing unit is also operable to perform recursive least squares to estimate an estimated sensor tilt for the one or more vision sensors that can reduce range errors in the vision sensors.

The details of various embodiments of the claimed invention are set forth in the accompanying drawings and the description below. Other features and advantages will become apparent from the description, the drawings, and the claims.

### DRAWINGS

FIG. 1 is a block diagram of one embodiment of an autonomous vehicle that obtains obstacle information;

FIG. 2 is a block diagram of one embodiment of a system for locating obstacles;

FIGS. 3A-3D are images of sensor information obtained from a camera and a lidar sensor;

FIG. 4 is a flowchart of one embodiment of a method for dynamically calibrating a monocular camera using a lidar sensor;

FIG. 5 is a block diagram of a geometric representation of one embodiment of a vision sensor mounted on a vehicle;

FIG. 6 is a flowchart of one embodiment of a method for data association between a camera and a lidar sensor; and

FIG. 7A-7C are block diagram views of one embodiment of a system for calibrating a sensor on an autonomous vehicle.

Like reference numbers and designations in the various drawings indicate like elements.

### DETAILED DESCRIPTION

Embodiments provide a method, system, and computer program product for tuning the external calibration parameters of a vision sensor by using information from a lidar sensor. The lidar sensor information is used for dynamic correction of external camera calibration parameters (mounting angles) used for obstacle range and azimuth computations. Improved values of these parameters are used to preprocess the data before the vision outputs are sent to a display. This leads to improved data association for objects reported by both sensors and improved accuracy of the vision measurements such as range and azimuth for all objects within the vision sensor's field-of-view (FOV). This method can also be used online (while the system is being used) for objects present in the intersection of the FOV of both sensors.

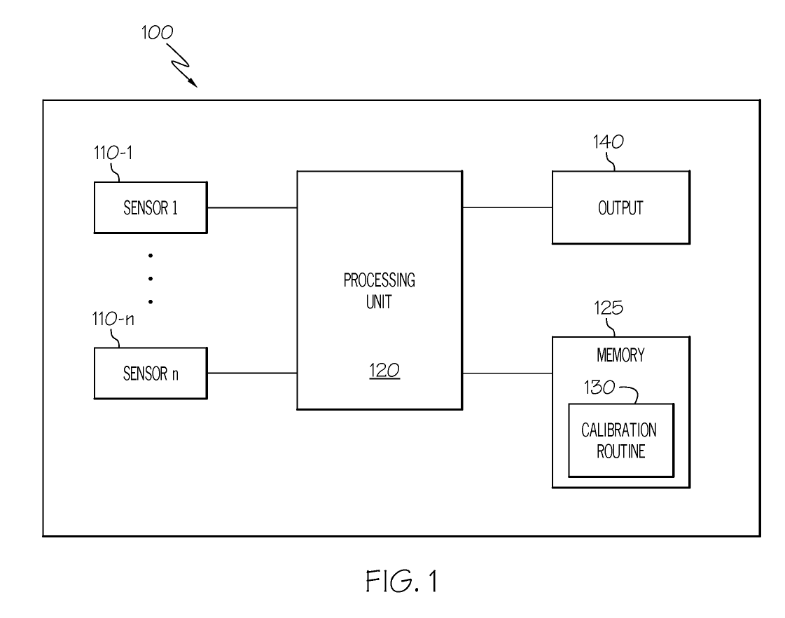

FIG. 1 is a block diagram of one embodiment of an autonomous vehicle 100 that obtains obstacle information. An autonomous vehicle 100 may be an unmanned aircraft, a driverless ground vehicle, or any other vehicle that does not require a human driver. Embodiments deal primarily with ground navigation, although it is to be understood that other embodiments can apply to air or other navigation systems as well. Obstacles are objects located near the vehicle 100, especially those located in the path of vehicle 100.

Sensors 110 are mounted on the vehicle 100. The sensors 110 consist of vision sensors (for example, a monocular camera), lidar sensors, radar sensors, or the like. To take the best advantage of different sensors, multiple sensors that have complementary properties (complementary in the sense that information from the sensors can be correlated) are mounted on the vehicle and the obstacle information is extracted using sensor fusion algorithms. As shown in FIG. 1, n sensors, 110-1 through 110-n, are mounted on vehicle 100. Objects in the FOV of sensors 110 will be detected as obstacles.

The autonomous vehicle 100 includes a processing unit 120 and a memory 125. The sensors 110 input sensor data to a processing unit 120. The memory 125 contains a calibration routine 130 operable to determine a correction for external camera calibration parameters. Processing unit 120 can be implemented using software, firmware, hardware, or any appropriate combination thereof, as known to one of skill in the art. By way of example and not by way of limitation, the hardware components can include one or more microprocessors, memory elements, digital signal processing (DSP) elements, interface cards, and other standard components known in the art. Any of the foregoing may be supplemented by, or incorporated in, specially-designed application-specific integrated circuits (ASIC) and field programmable gate arrays (FPGA). In this exemplary embodiment, processing unit 120 includes or functions with software programs, firmware or computer readable instructions for carrying out various methods, process tasks, calculations, and control functions, used in determining an error correction corresponding to external calibration parameters. These instructions are typically tangibly embodied on any appropriate medium used for storage of computer readable instructions or data structures.

The memory 125 can be implemented as any available media that can be accessed by a general purpose or special purpose computer or processor, or any programmable logic device. Suitable processor-readable media may include storage or memory media such as magnetic or optical media. For example, storage or memory media may include conventional hard disks, Compact Disk-Read Only Memory (CD-ROM), volatile or non-volatile media such as Random Access Memory (RAM) (including, but not limited to, Synchronous Dynamic Random Access Memory (SDRAM), Double Data Rate (DDR) RAM, RAMBUS Dynamic RAM (RDRAM), Static RAM (SRAM), etc.), Read Only Memory (ROM), Electrically Erasable Programmable ROM (EEPROM), and flash memory, etc. Suitable processor-readable media may also include transmission media such as electrical, electromagnetic, or digital signals, conveyed via a communication medium such as a network and/or a wireless link.

The processing unit 120 calculates parameters for calibrating the sensors 110 using calibration routine 130. The processing unit 120 also performs multi-sensor fusion to combine the sensory data. Sensor fusion is performed for fusing the information from the multiple sensors to obtain a single obstacle range and azimuth value of obstacles for further processing. Once the sensory data has been combined, the processing unit 120 outputs obstacle information to output 140. The output 140 may be a display, a graphical user interface (GUI), or the like.

Information from the sensors 110 on autonomous vehicle 100 are correlated to determine error corrections used for processing the information for display on output 140. Using the sensors 110 to correct errors instead of calibrating the system using, for example, a checkerboard pattern, allows the system to be calibrated during use.

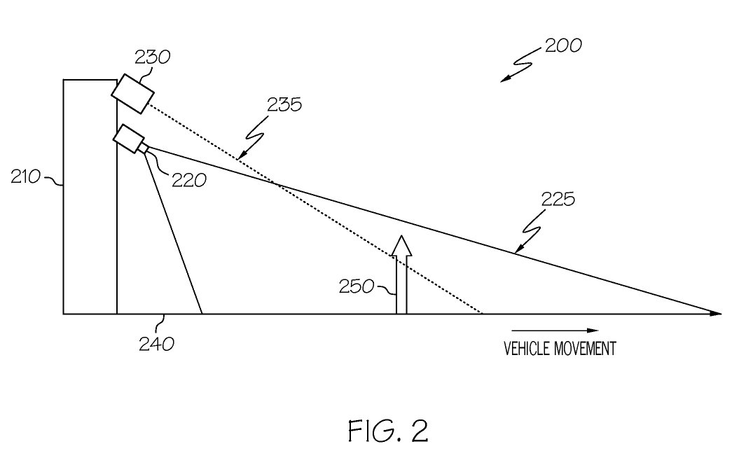

FIG. 2 is a block diagram of one embodiment of a system 200 for locating obstacles. The system 200 comprises a vehicle 210 with two sensors, 220 and 230, mounted thereupon. The sensor 220 is a vision sensor. In the embodiment of FIG. 2, sensor 220 is a monocular color camera. A second sensor 230 is also mounted on vehicle 210. In this embodiment, sensor 230 is a one axis lidar scanner (also referred to herein as a lidar sensor). Having a lidar sensor 230 and a monocular color camera 220 is an economic sensor choice. The monocular color camera (hereinafter referred to as the “camera”) 220 has a FOV 225. The lidar sensor 230 has a scan line 235. The lidar sensor 230 can rotate so that the lidar sensor 230 scan line 235 sweeps out an arc (corresponding to the lidar sensor's FOV).

FIG. 2 also shows the ground 240 which vehicle 210 moves across, as well as an object 250. The ground 240 is depicted in FIG. 2 as flat, but it is to be understood that the ground 240 may not be flat. The object 250 is an obstacle located in the path of the vehicle 210. As shown in FIG. 2, obstacle 250 is in the FOV of both the camera 220 and the lidar sensor 230. Note that both lidar sensor 230 and camera 220 are not parallel to the ground 240 but are each tilted by an angle. The critical parameter that can change the range of the object 250 as detected by the camera 220, and which can be changed with usage or by movement of the vehicle 210, is the camera tilt parameter. The angle that the camera is mounted at is the camera tilt parameter.

The ID lidar sensor 230 gives accurate range values of the obstacle 250 when the lidar sensor 230 ‘sees’ the obstacle 250 in its FOV. In contrast, the range information from the camera 220 may be inaccurate due to the inherent perspective geometry of the system 200 and the monocular transformation.

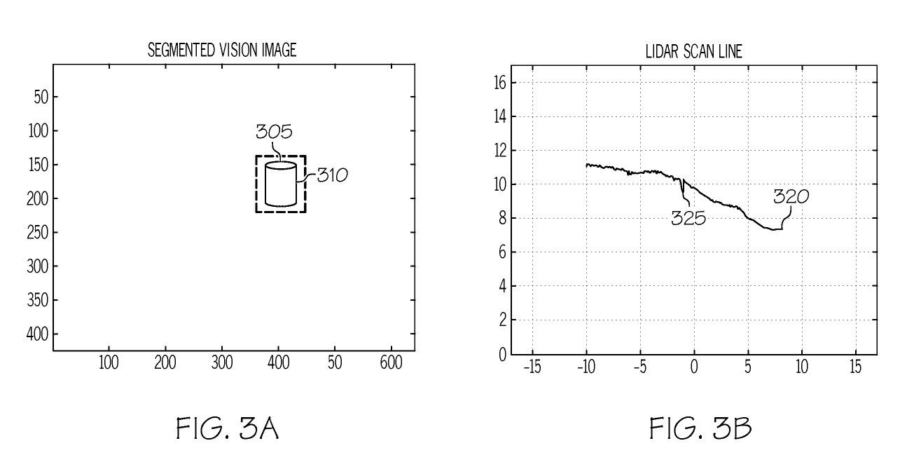

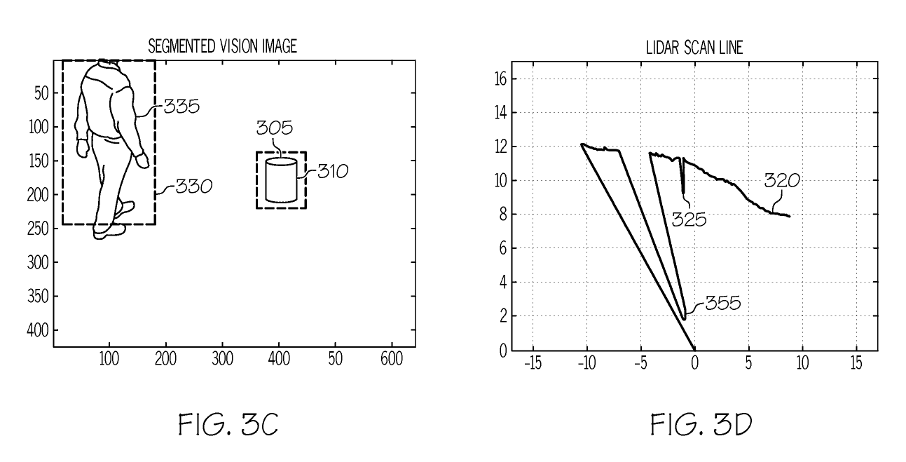

FIGS. 3A-3D are images of sensor information obtained from a camera and a lidar sensor. FIG. 3A shows a first scene of a display from a vision sensor, with an object of interest 305 bounded by a ‘vision sensor bounding box’ 310 which reduces the camera's image to a selected area of interest and identifies the boundaries of the obstacle 305 pixels. An object 305 can be seen in the image. FIG. 3B shows a lidar scan line 320 corresponding to the scene in FIG. 3A. The object 305 shown in FIG. 3A is within the lidar sensor's FOV, and is depicted as the negative spike 325 in FIG. 3B. The lidar sensor is located at (0,0) in the graph, corresponding to the nose of the vehicle to which the lidar sensor is mounted. The x-axis represents the lateral distance from the vehicle's center in meters. The y-axis represents the distance in front of the vehicle in meters. The lidar sensor scans an arc which has been clipped between −45 degrees and +45 degrees. The lidar sensor can scan any size arc (for example, 180 degrees), and is not limited to a 30 degree range. The lidar scan returns a line 320 corresponding to the distance between the sensor and an obstacle in that line of sight. These distances obtained from the lidar sensor are the ‘near ground truth’ range values. Typically, since the lidar sensor is mounted at an angle towards the ground, if there are no objects the lidar sensor will return the distance to the ground.

FIG. 3C shows a segmented vision image for a second scene. Here, another object 335 has entered the camera's FOV. The object 335 is bounded by bounding box 330. The corresponding lidar scan line for this scene is shown in FIG. 3D. As can be seen, the object 335 is detected by the lidar beam at 355, and is shown in the lidar scan line 350. While these examples show objects that are in the FOV of both sensors, there may be scenarios in which an object is not within the line of sight of the lidar beam but can be seen in the camera. This typically happens when the height of the object is not greater than the lidar beam height at that location from the ground.

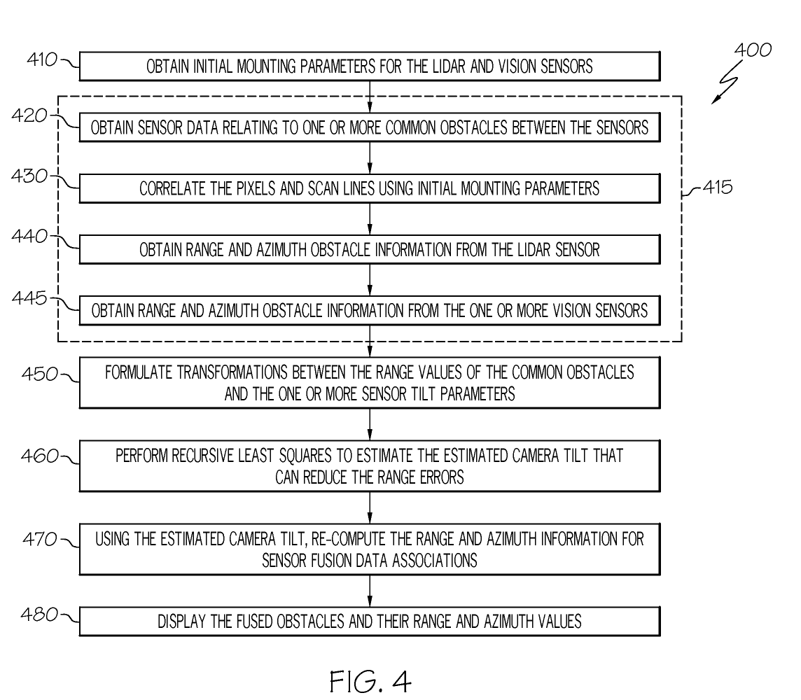

FIG. 4 is a flowchart of one embodiment of a method 400 for dynamically calibrating a monocular camera using a lidar sensor. A vehicle has a vision sensor and a lidar sensor mounted upon it. The method 400 begins with obtaining initial mounting parameters for the lidar and vision sensors (cameras) (block 410). These values describe the sensor's mounting and are used to align (register) the sensors. These values are typically obtained from the computer-aided design (CAD) values for the vehicle.

Once the sensors are initially calibrated, the method 400 performs data association of sensor information between the lidar sensor and the camera (block 415). The vehicle is operated and sensor data is gathered by the sensors (block 420). For example, the vehicle is run in the required navigation area (for some distance) and the range and azimuth values from individual sensors are obtained. Or the vehicle is stationary and the sensors obtain data corresponding to their field of view around the vehicle. Common obstacles (for example, the obstacles 305 and 330 in FIGS. 3C and 3D) in the sensors' FOV are identified and populated (block 420).

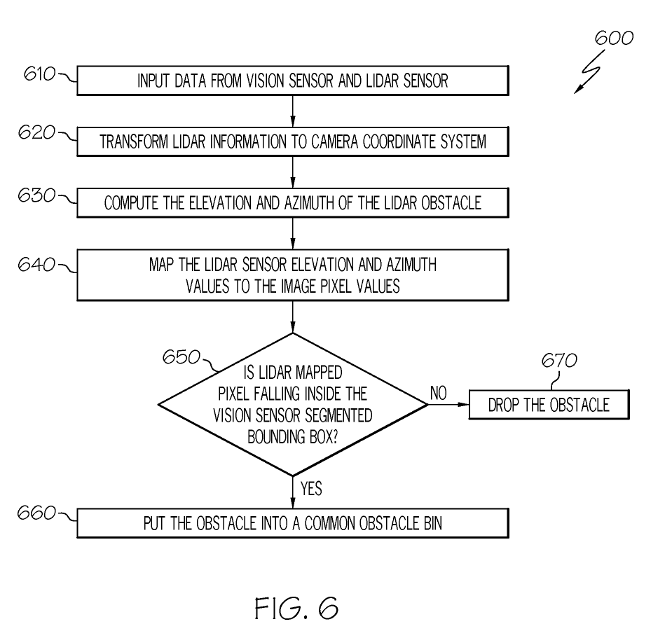

The method 400 also includes correlating the camera's pixels and the lidar sensor's scan lines (block 430). This correlation can be achieved by using a mounting CAD program. This ensures that the lidar and the camera are in a common reference frame. The reference frame can be the camera coordinate system. The lidar information is first converted to the image pixel frame. This mapping is done by using the inverse perspective camera geometry (converting world coordinates to pixel coordinates). Common obstacles are obtained by checking whether the lidar based pixel information falls within the vision sensor bounding box (hereinafter referred to as the bounding box), as discussed below in reference to FIG. 6.

Range and azimuth information for the common obstacles are obtained from the lidar sensor (block 440). An obstacle's range can be obtained directly from the lidar sensor information. Obtaining the azimuth, Θ, of an obstacle, M, requires calculation. For a lidar sensor with 180 degrees field of view, and an azimuth resolution, ΔΘ, of 0.5 degrees, the azimuth of the pixel corresponding to the M^{th} obstacle (counted from left to right) will be

Θ=ΔΘ·N−90.

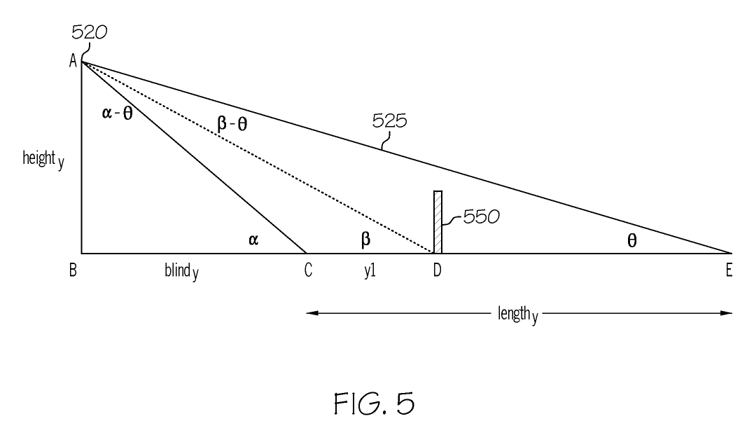

Range and azimuth information for the common obstacles are obtained from the one or more vision sensors (block 445). The azimuth of the obstacle in the vision sensor image can be obtained directly by computing coordinates of the center of the bounding box in the image coordinates. The x-coordinate (that is, the horizontal direction) is used to compute the azimuth angle of the obstacle in the camera frame. Obtaining the range from the vision sensor requires additional calculation. FIG. 5 is a block diagram of a geometric representation of one embodiment of a vision sensor mounted on a vehicle. The vision sensor 520 is mounted at point A. The line AB corresponds to the height of the vehicle, height_{y}. The line BC corresponds to the distance along the ground from the vehicle to the sensor's FOV (this distance is outside the vision sensor's FOV), blind_{y}. The line CE corresponds to the ground length of the camera's FOV, length_{y}. The line BD corresponds to the range of an obstacle 550. The angles α, β, and θ are as shown in FIG. 5. The range for the obstacle 550 in the vision sensor can be calculated by using the following relationships:

$$tan α = \frac{{height}_{y}}{{blind}_{y}}$$

$$tan θ = \frac{{height}_{y}}{{blind}_{y} + {length}_{y}}$$

$$θ = {tan}^{- 1} ( \frac{{height}_{y}}{{blind}_{y} + {length}_{y}} )$$

$$tan β = tan ( θ + \frac{{y}_{p}}{{I}_{h}} ( α - θ ) )$$

$$Range = \frac{{height}_{y}}{tan ( θ + \frac{{y}_{p}}{{I}_{h}} ( α - θ ) )}$$

where yₚ is the y coordinate of the given point (in this case the center point of the lower edge of the obstacle bounding box) in image coordinates and measured in number of pixels, and Iₕ is the vertical size (height) of the image in number of pixels.

Another method for performing data association of sensor information between the lidar sensor and the camera (block 415) is shown in FIG. 6. FIG. 6 is a flowchart of one embodiment of a method 600 for data association between a camera and a lidar sensor. The method 600 starts with receiving inputs from the vision sensor and from the lidar sensor (block 610). The vision sensor input can be of a bounding box which provides the extent of the obstacle as analyzed by the image processing method. Additionally, gating based solutions are largely used for data associations between the two sensors. In this context, a large gating region used for multi-sensor fusion leads to inaccurate associations, whereas smaller gates can miss out on lidar and vision outputs that are far apart. Once the data has been inputted (for example, to a processing unit), the lidar information is transformed to the camera coordinate system (block 620). Since the range computed from the camera using the above range formula could be quite off from the ground truth because of uncertain terrain, the data correlation should be done in the image frame. Converting the lidar observations into pixels and then correlating the data is done based on lidar obstacles that fall within the bounding box.

The elevation and azimuth of the obstacle from the lidar sensor's observations is computed (block 630). These values are mapped onto the image pixel values (block 640). Mapping the pixel values correlates the lidar sensor's information to that of the camera's. The method 600 queries whether the lidar mapped pixel for the obstacle falls inside the bounding box (block 650). If so, the obstacle is put into a common obstacle bin (block 660). Obstacles in the bin are considered for further processing. The obstacle can be stored in an obstacle bin in a memory unit. If not, the obstacle is dropped, or ignored (block 670).

Returning to FIG. 4, the method 400 formulates values (transformations) correlating the range values of the common obstacles to the sensor tilt parameters (block 450). Coarse information pertaining to parameters for vision perspective transformation from image frame to world frame is already known from the initial calibration of the sensor mounting angles. Based on this, errors can be found between the vision output detections and the lidar output detections in the world frame. Using this information along with the knowledge of the nonlinear perspective transformation, the error in the selected parameters of the transformation can be found by first linearizing the transformation and then applying recursive linear least squares. The critical parameter that can change the obstacle range is the camera tilt parameter. The camera tilt parameter is subject to change due to vehicle movement or usage. For example, vibrations over time can cause a change in the camera tilt, which can cause errors in the range estimates of obstacles in the camera's FOV. The camera tilt angle is corrected according to the ‘near ground truth’ range values from the lidar sensor using a recursive least squares algorithm over a length of vehicle runs (block 460). A recursive least squares is performed to estimate the estimated camera tilt that can reduce range errors.

To perform a recursive least squares, first the range must be obtained from the camera geometry. Yᵥ is the range computed from the bounding box. Mₕ is the camera mounting height. α and θ are angles as shown in FIG. 5. yₚ is the row value of the lower edge of the bounding box. Iₕ is the image height, which is the height of the bounding box. Therefore, the range is given as:

$${Y}_{v} = {M}_{h} \cdot tan ( θ + ( α - θ ) \frac{{y}_{p}}{{I}_{h}} )$$

Hence, the range can be written as:

Y=f(α,θ)

Thus, the errors in the range information from the camera can be minimized by re-estimating the α and θ values, corresponding to the camera tilt. The inaccurate range (the range with errors) can be written as:

Y=f(α₀+δ_{α},θ₀+δ_{θ})

Y can be linearized by using a Taylor series expansion:

$${Y}_{0} + Δ Y = f ( {α}_{0} {θ}_{0} ) + \frac{\partial f ( α , θ )}{\partial α} Δα + \frac{\partial f ( α , θ )}{\partial θ} Δ θ$$

Since the lidar sensor gives accurate range information, Y₀=f(α₀,θ₀), therefore:

$$Δ Y = \frac{\partial f ( α , θ )}{\partial α} Δα + \frac{\partial f ( α , θ )}{\partial θ} Δθ$$

Shown in matrix form, the change in range, ΔY, is:

$$[ \frac{\partial f}{\partial α} \frac{\partial f}{\partial θ} ] [ \begin{matrix}Δα \\ Δθ\end{matrix} ] = Δ Y$$

Obtaining multiple samples (corresponding to multiple objects), the above equation can be solved using recursive least squares formulation. These values are the corrections to the initial angle, the camera tilt angle.

Once the estimated camera tilt angle is obtained, the range and azimuth information for sensor fusion data associations is re-computed using the estimated camera tilt (block 470). The transformation parameters can again be fine tuned to get the correct vision obstacle information for all the obstacles which are within the camera's FOV. The range and azimuth information can be re-computed for sensor fusion data associations using the estimated camera tilt. This correction can be carried on in real-time for autonomous navigation. The fused obstacles and their corresponding range and azimuth values are displayed, or outputted (block 480).

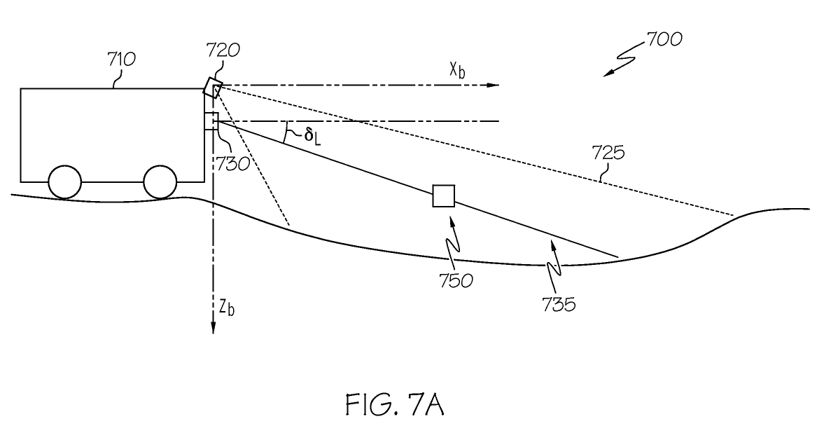

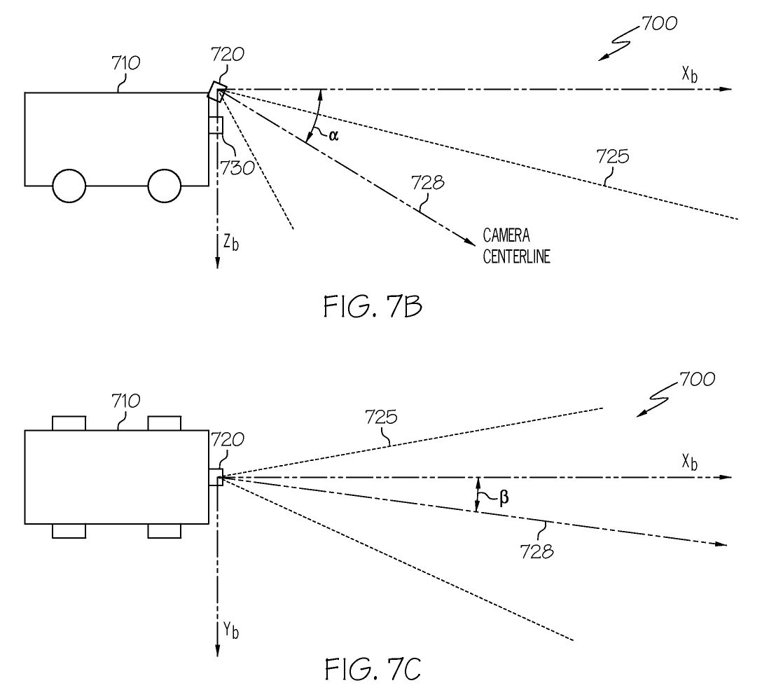

FIG. 7A-7C are block diagram views of one embodiment of a system 700 for calibrating a sensor 720 on an autonomous vehicle 710. A different formulation than that described above can be used to compute the sensor alignment angles by comparing the sensor 720 with another reference sensor 730. The sensor 720 is a camera and the sensor 730 is a lidar sensor. The camera 720 has a FOV 725. The lidar sensor 730 has a FOV 735. This approach is applicable for point obstacles 750 and does not assume a flat ground 740 for correlating ranges from the camera 720 and lidar sensor 730. The alignment angles are obtained by doing a least squares fit to obstacles 750 in the image. The same recursive least squares technique described above is applicable here.

The axes (x_{b}, z_{b}) represent the body axes of the vehicle 710 (the vehicle body reference frame), with the origin at the vision sensor 720. The lidar beam downward angle (with respect to x_{b}), δ_{L}, is known from the vehicle 710 design specifications. The lidar sensor 730 gives the range and azimuth of the point obstacle 750. Knowing the lidar beam downward angle, δ_{L}, allows the coordinates of the obstacle 750 to be obtained in the vehicle body reference frame. The body frame coordinates of the obstacle 750 can be used to compute the elevation azimuth angles of the obstacle 750 in the camera image. A comparison of the vision image with the lidar obstacle transformation can be used to correct for mismatch arising due to errors in the camera mounting angles.

FIG. 7B shows a side view of the system 700. The camera 720 and lidar sensor 730 are mounted on the vehicle 710. The camera tilt angle α is measured between x_{b} and the camera centerline 728. FIG. 7C shows a top view of the system 700. The camera 720 is shown mounted on the vehicle 710. Another camera tilt angle β is measured between x_{b} and the camera centerline 728.

Given the range and azimuth, denoted as (r, θ), of the obstacle in the lidar beam, and the location of the lidar sensor 730 in the body frame (x_{L}, y_{L}, z_{L}), the Cartesian components of the lidar report (what the lidar sensor 730 detects) in the body frame are given by:

x_{b}=r cos(θ)cos(δ_{L})+x_{L}

y_{b}=r sin(θ)+y_{L}

z_{b}=r cos(θ)cos(δ_{L})+z_{L}

The azimuth, Az, and elevation, El, of the obstacle can be calculated using the following transformation:

Az=a tan(y_{b},z_{b})

El=a tan(x_{b},z_{b})

The azimuth and elevation values can be converted into equivalent pixel numbers (corresponding to the camera's image), referenced from the bottom left corner. E_FOV and A_FOV are the elevation and azimuth field-of-views for the camera 720, respectively. The total image size of the camera 720 image is nₓ by n_{y}. Thus, the azimuth and elevation values are given as:

$${N}_{xL} = \frac{( Az - α )}{{E}_{FOV}} {n}_{x} + {n}_{x}$$

$${N}_{yL} = \frac{( Az - β )}{{A}_{FOV}} {n}_{y} + {n}_{y}$$

Given a vision report at (N_{xV}, N_{yV}), the cost function, J, to be minimized is the mismatch of the ranges between the two sensors. Solving the least squares problem to find the value of the offsets (α, β) such that the cost function,

$$J = {\sum }_{i} ( {( {N}_{xV} - {N}_{xL} )}^{2} + {( {N}_{yV} - {N}_{yL} )}^{2} )$$

is minimized, gives the camera tilt angles. These camera tilt angles can then be used to calibrate the camera. The calibrated camera information is then used in a sensor fusion process. In alternate embodiments, the camera tilt angles can be used to tilt the one or more vision sensors to obtain accurate sensor data. In this case, the sensor data does not need to undergo pre-processing before sensor fusion is performed.

Calibration of the sensors can be incorporated dynamically into the Perception/Navigation Solution based on the auto-associations and the disassociations seen. The Perception/Navigation Solution deals with a perception unit (a unit that performs obstacle detection) and a navigation unit (including obstacle avoidance and path planner modules). Dynamic calibration of external sensor parameters can be performed to compensate for any change in camera mounting over time due to vibrations or changes with the mounting mechanisms, which can reduce errors in range estimates of obstacles within the sensor's FOV. Once the sensors are calibrated, sensor fusion is performed for fusing the information from the above two sensors to obtain a single obstacle range and azimuth value for further processing.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A method for calibrating sensors mounted on a vehicle, comprising:
obtaining sensor data relating to one or more common obstacles between the one or more vision sensors and a lidar sensor;
correlating the lidar sensor data pertaining to the one or more common obstacles with the one or more vision sensors pixels;
calculating range and azimuth values for the one or more common obstacles from the lidar sensor data;
calculating range and azimuth values for the one or more common obstacles from the one or more vision sensor data;
formulating translations between the range values of the one or more common obstacles and the one or more sensor tilt parameters; and
perform recursive least squares to estimate an estimated sensor tilt for the one or more vision sensors that can reduce range errors in the vision sensors.

2. The method of claim 1, further comprising:
calculating the range and azimuth information for the one or more common obstacles using the estimated sensor tilt;
performing sensor fusion on the one or more common obstacles; and
announcing to a processor the one or more fused obstacles and their range and azimuth information.

3. The method of claim 1, further comprising:
initializing alignment and mounting of the lidar sensor and the one or more vision sensors on the vehicle.

4. The method of claim 1, further comprising:
performing on-line preprocessing of sensor measurements for sensor fusion.

5. The method of claim 1, wherein the method is performed off-line and further comprises:
repeating the method from time to time to ensure correctness of the estimated calibration parameters.

6. The method of claim 1, further comprising:
calibrating the one or more vision sensors using the estimated sensor tilt.

7. The method of claim 1, wherein obtaining sensor data relating to one or more common obstacles between the one or more vision sensors and a lidar sensor further comprises:
obtaining sensor data relating to one or more vision sensor segmented bounding boxes corresponding to the one or more common obstacles.

8. The method of claim 1, wherein the one or more vision sensors comprises:
at least a monocular color camera.

9. An autonomous vehicle navigation system, comprising:
one or more vision sensors mounted on a vehicle;
a lidar sensor mounted on the vehicle;
a processing unit coupled to the one or more vision sensors and the lidar sensor operable to:
receive data pertaining to the initial alignment and mounting of the lidar sensor and the one or more vision sensors on the vehicle;
receive data relating to one or more common obstacles between the one or more vision sensors and the lidar sensor;
calculate range and azimuth values for the one or more common obstacles from the lidar sensor data;
calculate range and azimuth values for the one or more common obstacles from the one or more vision sensor data;
correlate the lidar sensor data pertaining to the one or more common obstacles with the one or more vision sensors pixels;
formulate translations between the range values of the one or more common obstacles and the one or more sensor tilt parameters; and
perform recursive least squares to estimate an estimated sensor tilt for the one or more vision sensors that can reduce range errors in the vision sensors.

10. The system of claim 9, wherein what the processing unit is operable for further comprises:
calculate the range and azimuth information for the one or more common obstacles using the estimated sensor tilt;
perform sensor fusion on the one or more common obstacles; and
announce to a display the one or more fused obstacles and their range and azimuth information.

11. The system of claim 9, wherein what the processing unit is operable for further comprises:
performing on-line preprocessing of sensor measurements for sensor fusion.

12. The system of claim 9, wherein the one or more vision sensors comprises:
at least a monocular color camera.

13. The system of claim 9, wherein the lidar sensor can scan at least 180 degrees.

14. A computer program product, comprising:
a computer readable medium having instructions stored thereon for a method of calibrating one or more sensors on a vehicle, the method comprising:
obtaining sensor data relating to one or more common obstacles between the one or more vision sensors and a lidar sensor;
calculating range and azimuth values for the one or more common obstacles from the lidar sensor data;
calculating range and azimuth values for the one or more common obstacles from the one or more vision sensor data;
correlating the lidar sensor data pertaining to the one or more common obstacles with the one or more vision sensors pixels;
formulating translations between the range values of the one or more common obstacles and the one or more sensor tilt parameters; and
perform recursive least squares to estimate an estimated sensor tilt for the one or more vision sensors that can reduce range errors in the vision sensors.

15. The computer program product of claim 14, further comprising:
calculating the range and azimuth information for the one or more common obstacles using the estimated sensor tilt;
performing sensor fusion on the one or more common obstacles; and
announcing to a processor the one or more fused obstacles and their range and azimuth information.

16. The computer program product of claim 14, further comprising:
initializing alignment and mounting of the lidar sensor and the one or more vision sensors on the vehicle.

17. The computer program product of claim 14, further comprising:
performing on-line preprocessing of sensor measurements for sensor fusion.

18. The computer program product of claim 14, wherein the method is performed off-line and further comprises:
repeating the method from time to time to ensure correctness of the estimated calibration parameters.

19. The computer program product of claim 14, further comprising:
calibrating the one or more vision sensors using the estimated sensor tilt.

20. The computer program product of claim 14, wherein obtaining sensor data relating to one or more common obstacles between the one or more vision sensors and a lidar sensor further comprises:
obtaining sensor data relating to one or more vision sensor segmented bounding boxes corresponding to the one or more common obstacles.
